(19) United States
(12) Patent Application Publication
(10) Pub. No.: US 2018/0297813 A1
(43) Pub. Date: Oct. 18, 2018

(54) DEVICE FOR ADJUSTING THE POSITION OF AN ELEVATOR SYSTEM, AND ELEVATOR SYSTEM

(71) Applicant: ELGO ELECTRONIC GMBH & CO. KG, Reilasingen (DE)

(72) Inventor: Heiko Essinger, Rielasingen-Worblingen (DE)

(21) Appl. No.: 15/767,799

(22) PCT Filed: Oct. 13, 2016
(86) PCT No.: PCT/EP2016/074599

§ 371 Date: Apr. 12, 2018

(30) Foreign Application Priority Data
Oct. 13, 2015 (DE) 20 2015 105 420.3

(51) Int. Cl. B66B 1/34; B66B 3/02

(52) U.S. Cl. CPC B66B 1/3492; B66B 3/02

(57) ABSTRACT

A device for adjusting the position of an elevator system, having position measuring means (14) that can be assigned to an elevator car (2) which is movable in an elevator shaft (6), which are designed for generating position data corresponding to a current shaft position of the elevator car, and position control means (34) which interact with the position measuring means (14) and which are paired with configuration means (16) that can be actuated manually and/or by means of data input means, in such a way that as a response to a manual actuation and/or actuation of the data input means, a plurality of car stopping positions that are distributed along the elevator shaft can be adjusted and stored, wherein a mobile data processing unit (26) which is wirelessly linked to the configuration means and which has a display unit (28) is paired with the configuration means (16), such that position data corresponding to the plurality of car stopping positions can be displayed together on the display, and the mobile data processing unit has manually actuatable operating means (28) for changing at least one of the items of position data and for transmitting the changed item of position data to the configuration means.

### BACKGROUND OF THE INVENTION

The present invention relates to a device for adjusting the position of an elevator system. The present invention also relates to an elevator system using such a position adjusting device.

Generic devices for the position adjustment of an elevator system are commonly known from the prior art; in particular, these devices are used in an installation and maintenance operating mode of an elevator system to move the elevator car, which is movably driven in the elevator shaft, to designated stopping positions in the elevator shaft—these being usually respective floors and therefore designated car door opening positions—so that the car stopping positions can then be adjusted and stored. To this end, in an otherwise well-known manner, position measuring means are assigned to the elevator car, which generate position data corresponding to a current shaft position of the elevator car and typically provide them to a further computational processing stage. Such position measuring means are known, for example, in the form of a carriage unit comprising magnetic field detectors (as a position sensor), which is fixed to the elevator car and can be displaced relative to a magnetized longitudinal encoding extending along the elevator shaft by movement of the elevator car. In accordance with the magnetic encoding, the readout and conversion is then carried out by magnetic field sensors followed by conversion into (current absolute or relative) position data.

This position data functionality is also used for an installation and/or configuration operating mode of the elevator system. For this purpose, an operator drives the elevator car along the elevator shaft, usually by means of manual motion control, stopping at the predetermined or designated car stopping positions there—in other words, the positions corresponding to the respective floors. Associated position data are then collected, stored and supplied to the automated elevator controller provided for the subsequent operation, in such a manner that the position control means performing the elevator control and positioning can travel to the selected or designated floors corresponding to these stored position data in a targeted manner.

This installation and/or configuration mode is commonly known and proven in practice, but is nevertheless tedious in its practical implementation, so that, in particular due to compliance with the relevant safety regulations, significant configuration time is required for the described installation procedure. Last but not least, the known method of handling the configuration means—usually by means of cables of plug-in connectable control units with numeric displays and mechanical control knobs—is cumbersome in its handling, potentially error-prone and requires careful instruction and training of the operating personnel. Added to this is the fact that, for the practical configuration and adjustment mode, for the plurality of car stopping positions along an elevator shaft unambiguous position data cannot always be generated from the position measuring means. For example, hysteresis effects are to be expected in the event that a car stop position is approached from two opposite directions of car motion, in the same way as a car speed or car acceleration up to the stopping position also influences position data, which must then be stored in the standard manner.

Last but not least, it is also the case that the technology which is presupposed as forming the basis of the generic device is limited in its user-friendliness and in particular, has low tolerance with regard to imprecise position data, to the extent that the operator has no or only limited opportunity to manually influence the position data or to change them.

### SUMMARY OF THE INVENTION

The object of the present invention therefore is to simplify a generic device for adjusting the position of an elevator system in terms of its ease-of-use, and in particular to design the configuration and installation mode for the plurality of car stopping positions so that it is easier, faster, involves less training and monitoring effort and is more fault-tolerant, with particular attention to facilitating the handling of potentially inaccurate or erroneous position data.

The object is achieved by the device for position adjustment of an elevator system having the features disclosed herein; advantageous extensions of the invention are also described herein. In addition, protection within the scope of the invention is claimed for an elevator system as disclosed herein, which provides the device for the position adjustment according to the independent claim for an elevator car which is movable in an elevator shaft. To this extent the invention is not restricted to an overall system, in particular the device for position adjustment according to the invention should be understood to also refer to a device which neither claims nor has the elevator shaft, nor the elevator car moving within it, as inventive features.

In an advantageous manner according to the invention, a wirelessly connected mobile data processing unit is first assigned to the configuration means, which not only drastically simplifies the handling and flexibility in the configuration, but also within the scope of the invention also allows the presentation of the plurality of car stopping positions jointly via the display for viewing by the operator. In this case, this presentation can be preferably effected in tabular and/or graphic form or in any other suitable way to illustrate the relationship between the individual positions, for instance, including the fact that these can be arranged along a symbolic vertical direction—thus corresponding to the elevator shaft—with the purpose of giving the operator a simple overview of car stopping positions that are already installed or yet to be installed, and at the same time, enabling these intervals to be checked for uniformity, for example using simple calculations, which can also be provided by the data processing unit by means of additional calculation functions of the position data on the display. It follows from this that the display or the display unit according to the invention should advantageously be a display unit which is suitable for displaying high-resolution images, of such a type that, for example, the chart to be preferably displayed showing all the car stopping positions with assigned position data can then be visually compared against the corresponding elevator stopping positions or floor numbers in tabular form, either as a whole or at least partially, in which case an image shifting or scroll functionality can also be implemented as necessary.

In addition, the invention has provision for assigning the manually actuatable control means to the mobile data processing unit for changing at least one of the position data items. This can be realized in a doubly synergistic way, for instance, if the display unit, more preferably designed in the form of a touch-sensitive display, enables the operator to select a position data item to be changed not only simply by means of touch, but then for instance, suitable switches or control buttons can also be configured in the form of commonly used buttons on the touch-sensitive display for performing the change according to the invention. The synergy according to the invention is also achieved by further functionalities relating to upstream or downstream positions then being displayed to the operator automatically as a result of changes in relative distances, so that again in this respect, the control and handling convenience during the installation phase is made considerably easier.

This applies also to the processing according to an extension of a plurality of position data for one of the elevator stopping positions—this might arise, for example, because the operator approaches the designated elevator stopping position (in the context of the present disclosure, also designated as a car stopping position) multiple times and possibly from different directions, with different accelerations etc., and then from different position values resulting from these either makes a selection of a suitable value manually, has the data processing unit perform an averaging or other prioritization, or in some other way then arrives at a favourable optimal position value, in any case one which is attainable with little effort.

In the practical implementation of the invention and to provide the wireless connection of the data processing unit to the configuration means, radio links are preferred in the context of the invention, wherein for the short-range to be resolved here in particular a Bluetooth connection is more preferable, but does not definitively limit the scope of the invention.

In order to further increase the convenience of operation during the configuration and to provide improved information to the operator handling the data processing unit, in accordance with an extension additional provision is made for obtaining a car speed signal and/or a car travel direction signal from the position measuring means; in an already known manner it is clear to the person skilled in the art that from a sequence of changing position data the mean position of these additional information items can be readily generated and then within the context of preferred extensions, can be suitably displayed on the display unit in addition.

For example, for the above-described purpose of improving a fine adjustment, it is often useful for the operator to obtain this additional information concerning the current travelling mode of the elevator car.

In a particularly preferred manner from a design point of view, extensions of the invention provide in particular for the position measuring means according to the invention and the configuration means according to the invention to be integrated in a modular way, wherein this is preferably achieved in an extension by, for example, the respective modules being integrated on a common carrier unit and this carrier unit then being able to be fixed on or onto an elevator car at a suitable mounting location. In view of the need for the position measuring means to be fixed to the car to interact with typically stationary length encoding means on or in the elevator shaft, the pairing of the configuration means is recommended, not least as possibly additionally synergistic common electronics modules, such as a micro-controller or microprocessor-based configuration control unit, can also be used for the position measurement and decoding, or vice versa.

It is also advantageously provided in the form of an extension to assign to this module arrangement (or to the configuration means separately, should these be provided as isolated units) configuration enabling means, which are implemented more preferably in the form of an actuation switch and must be physically actuated by the operator, in order to be able subsequently to perform the configuration operation in the above described manner, for example from an operating position on the elevator roof.

A further advantageous design of the invention, which is also to be regarded as the best mode, provides for safety switches to be assigned to the position measuring means and the configuration means—ideally provided adjacent to each other, see above—which are provided to allow a controlled interruption of a car door opening function of the elevator car. Specifically, these are activated by the positioning means and the configuration means in such a way that a car door opening (for example, by means of a closed relay of the safety switch) is only enabled when position data of the position measuring means correspond to the adjusted and stored car stopping positions, or do not deviate from them by more than a predefined tolerance. This measure also increases the safety of the configuration operation significantly by means of a simple design modification.

As a result, the present invention can then be used to implement an elevator system, which combines dramatically simplified configuration with increased operating convenience, higher operational safety during the configuration stage and significantly reduced configuration times and training times.

### BRIEF DESCRIPTION OF THE DRAWINGS

Further advantages, features and details of the invention can be found in the following description of preferred exemplary embodiments and from the drawings, which show in

FIG. 1 a schematic side view of an embodiment of the invention as an elevator system with an elevator car that can be moved in an elevator shaft, to illustrate the usage context of the invention and

FIG. 2 a schematic block circuit diagram of a device for adjusting the position of the elevator system according to FIG. 1 as a first exemplary embodiment of the invention.

### DETAILED DESCRIPTION

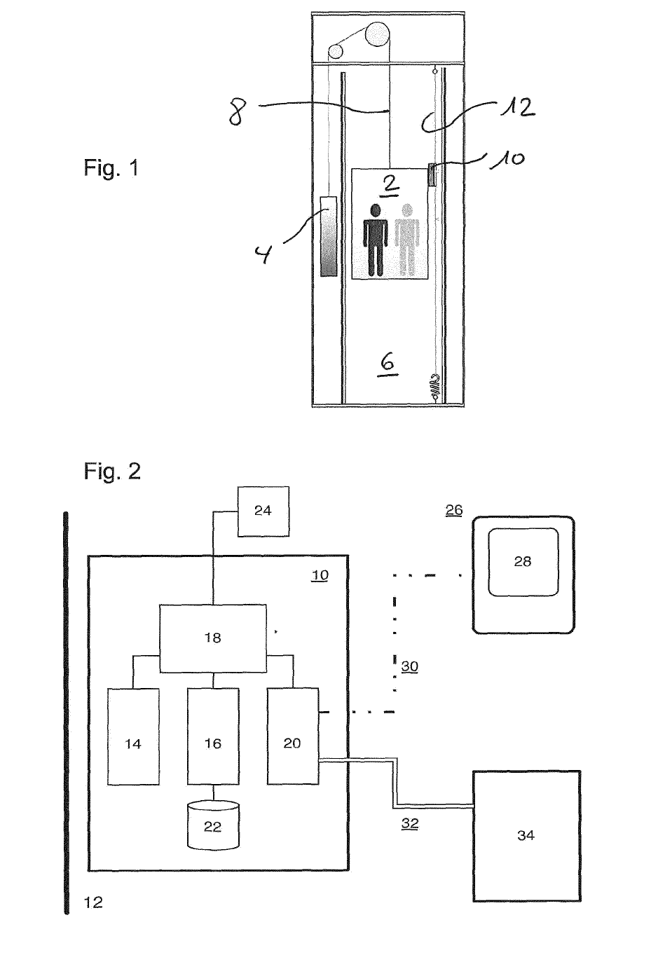

FIG. 1 illustrates schematically—in particular, the dimensions of the figure are not in proportion—the essential realization of an elevator system according to the invention for the preferred application context of the present invention. An elevator car 2, driven by schematically represented drive means 4, is mounted in an elevator shaft 6 such that it can be moved in the vertical direction, wherein the elevator car is suspended on a sling 8 driven by the device 4 such that it can be transported. The elevator car 2 is additionally displaceable along a position encoding 12 provided in the vertical extension of the shaft 6 in the form of a coded (here in absolute form) magnetic strip, in such a way that position detection and adjustment means 10, fastened to an upper roof area of the car 2, move along the coded strip 12 during the movement of the car and, by means of suitable magnetic field detectors in the assembly 10, detect a current magnetization at a current position of the car and then convert it into positional or motion and speed data. This technology is known as such, and is successfully implemented and commercially exploited by the applicant, among others.

Against this background, FIG. 2 shows the schematic detailed design and functional implementation of the position adjustment and measuring device 10 according to FIG. 1, which in this respect represents a preferred embodiment of the invention. The block circuit diagram within the outline of the assembly 10 shows firstly that position measuring means 14, which are located opposite the coded strip to provide effective detection, supply a current position by means of decoding and, if necessary, fine interpolation (by means of additional magnetic field sensors), for further processing by a central control unit 18.

The central control unit 18 is also connected to a configuration unit 16 (configuration means), in such a way that using the assembly 16, both predetermined position data for car stopping positions along the shaft direction can be detected (and can be subsequently stored in permanent data storage means 22), but then equally during a subsequent continuous operation of the elevator system predetermined or selected settings, such as floor numbers, can be supplied or passed back by means of the configuration unit and the data stored in the unit 22, in such a way that the elevator car can be positioned in accordance with the preselected position. This functionality is implemented via the position control unit 34 (position control means), which is connected by means of a data line 32, which can usually be provided separately from the modular designed unit 10, either on the elevator car itself or alternatively at a fixed position on or in the elevator shaft. These position control means in turn perform, in an otherwise known manner, the operation of the drive means 4, 8 for an elevator car 2 such that this can travel to its predefined position (according to the configuration 16, 22).

As the block circuit diagram of FIG. 2 illustrates, a communication interface 20 provided in the unit 10 performs the electronic data communication to the position control means 34. In addition, the block circuit diagram of FIG. 2 illustrates how a portable data processing unit 26 is connected wirelessly via the communication interface unit 20; the double dash-dotted line 30 in FIG. 2 illustrates a commonly used Bluetooth data connection to this portable data processing unit 26, which can be realized in otherwise known ways, for example in the form of a tablet computer, PDA, smartphone, etc. In the exemplary embodiment shown here, this portable data processing unit is equipped with a touch-sensitive screen unit 28, which can not only display graphics and/or complex presentations with high-resolution quality for an operator, but the touch-sensitive display unit 28 also implements manual user interfaces, for example using specially provided and possibly context-sensitive control buttons formed on the display 28, which can then be selected or actuated by an operator as appropriate.

The block circuit diagram of FIG. 2 also illustrates a manually actuated switch unit 24, connected to the central control unit 18, which is provided outside of a module housing for the module 10 and must be actuated manually by an operator to initiate a configuration operating mode of the system according to FIG. 1, to be described in detail below.

Specifically, by activating the switch unit 24 (which in fact will also be designed in the manner of a commonly known emergency switch), an operator would enable or actuate a configuration operating mode, so that suitable configuration data can then be received, analysed and, if necessary, changed or manipulated by means of the wirelessly connected data processing unit 26. For this purpose, an operator, who during the operation can be typically positioned either inside the car 2 or on the roof of the car 2, initially positions the car under manual control (not shown in detail) using the position control means 34 at a position which corresponds to a floor position to be configured. This resulting relative position between the car 2 and code strip 12 leads to the generation of a position signal (in this case unique due to the absolute encoding) by the position sensor 14, wherein this position signal, suitably converted for example into a dimensional or height specification in the shaft, is transmitted by means of the central control unit 18 and the interface unit 20 to the data processing unit 26, where it is displayed, for example in the form of a number pair (floor number, absolute position specification) on the display 28. After the operator, for example, has then confirmed this position and travels to a different position (e.g. corresponding to an alternative floor number), the associated floor information and height information are here also displayed to the user on the display 28, ideally in the form of a chart, so that, possibly further graphical or numerical processed, the operator can not only visually check each individual measurement and floor specification, but can also carry out this check as a whole on the basis of the chart, perhaps by the fact that the system additionally computes and indicates whether the relative distances between individual successive floors are actually equal, or whether there are dimensional, measurement or position errors.

Through appropriate operation of the touch-sensitive display 28, the operator is then enabled to access the single position values that are displayed individually, for example by the fact that in an otherwise known way by touching, a selection is made of a value to be processed and then by means of appropriate control buttons, such as “plus” or “minus”, a manual fine-tuning and correction can be performed. In this way, the operator is then allowed to generate in a simple, clear, reliable and user-friendly way, a complete conclusive set of position data which form the basis of the configuration, and which then, for permanent storage in the unit 22 and for future use in a continuous operation of the elevator system by the unit 34, can form the basis of the positioning.

In accordance with a preferred extension of the invention it is also possible to record a plurality of position data for each elevator car position (to be configured or approached) along the coding path 12 as well; this is used, for example, to interpolate an optimal value or to form a mean value from a plurality of measurements. Thus, for example, due to the inherent hysteresis behaviour of the position measuring arrangement, it is conceivable that these position specifications vary because an operator approaches a predetermined elevator position from two directions (i.e. from above or from below), with the possible consequence that a manual user intervention gives rise to a selection or to the formation of a mean value, etc., of the final position value. In this respect, a tabular and visual layout enabled by the graphics-capable display arrangement 28 is the ideal way to solve this complex configuration task easily and reliably.

Irrespective of these exemplary control operations, it is within the scope of the technical design of the invention both to further develop and design the operator interface as desired—thus for instance using “plus” or “minus” control buttons, predetermined elevator positions can be selected or approached, and a delete function can also be selected with the purpose of making a repeated approach to an unintended position following an operator error, and reconfiguring it.

In addition, during the configuration it may be useful to additionally display to the operator acceleration and/or speed values of a (current) car movement, and for example, in an otherwise known manner, access protection or other security measures can also be performed on the configuration. It is within the scope of the practical design of the invention to provide these measures in particular in the form of standard application software applications using known distribution platforms, thus ensuring a permanent updating of this technology even in the event of its widespread use. As a result, in a surprisingly simple and elegant way the present invention achieves the significant improvement of the configuration and installation operation of an elevator system with the adjustment (teaching) of respective elevator stopping positions (floor positions) relative to a position on the longitudinal coding. In addition, the advantage is obtained that as a result of the integration of the position measurement and the configuration means, in particular, in a modular fashion in or on a common carrier unit for fitting them on the car enables a simple, easily maintained and user-friendly method of implementing this technology to be created, not least as appropriate mechanical infrastructure is already available in the form of commonly used positioning systems.

1. A device for adjusting the position of an elevator system, having
position measuring means (14) that can be assigned to an elevator car (2) which is movable in an elevator shaft (6), which are designed for generating position data corresponding to a current shaft position of the elevator car,
and position control means (34) which interact with the position measuring means (14) and which are paired with configuration means (16) that can be actuated manually and/or by means of data input means, in such a way that as a response to a manual actuation and/or actuation of the data input means, a plurality of car stopping positions that are distributed along the elevator shaft can be adjusted and stored,
wherein
a mobile data processing unit (26) which is wirelessly linked to the configuration means and which has a display unit (28) is paired with the configuration means (16), such that position data corresponding to the plurality of car stopping positions can be displayed together on the display,
and the mobile data processing unit has manually actuatable operating means (28) for changing at least one of the items of position data and for transmitting the changed item of position data to the configuration means.

2. The device according to claim 1, wherein the control means are implemented as at least one touch-sensitive switching or actuation surface on the touch-sensitive display unit (28).

3. The device according to claim 1, wherein the data processing unit (26) is connected to the configuration means via a bi-directional wireless link (30), and in particular implements a radio transmission protocol according to a Bluetooth or WLAN standard.

4. The device according to claim 1, wherein the data processing unit is designed for receiving a plurality of position data items corresponding to one of the car stopping positions and with processing means for selecting one of the position data items and/or for prioritizing or averaging the plurality of the position data items.

5. The device according to claim 1, wherein the position measuring means (14) are designed for additionally generating a car speed signal and a current car speed and/or a car speed which is valid at a predetermined or pre-determinable time can be additionally displayed on the display unit (28).

6. The device according to claim 1, wherein the position measuring means (14) are designed for additionally generating a travel direction signal of the car and a current car travel direction can be additionally displayed on the display unit.

7. The device as claimed in claim 1, wherein the position measuring means (14) and the configuration means (16) are implemented in a modular fashion on a common carrier unit or on adjacent carrier units that can be provided on an elevator car.

8. The device according to claim 1, wherein configuration enabling means (24) provided for manual actuation, in particular in the form of an actuation switch, are physically assigned to the configuration means.

9. The device according to claim 1, wherein safety switches for the controlled interruption of a car door opening function of an elevator car are assigned to the position measuring means and the configuration means, so that the opening of a car door is only allowed if position data items of the position measuring means correspond to the adjusted and stored car stopping positions, or deviate from them by no more than a pre-defined tolerance level.

10. An elevator system with an elevator car (2) which is movable in an elevator shaft (6) and to which the device of claim 1 is fixed.

11. The device according to claim 1, wherein the car stopping positions can be displayed together on the display in tabular form and/or in the form of graphical elements.

12. The device according to claim 3, wherein the bi-directional wireless link implements a radio transmission protocol according to a Bluetooth or WLAN standard.

13. The device according to claim 8, wherein the configuration enabling means (24) is an actuation switch.

14. The system of claim 10, wherein the device of claim 1 is fixed on a roof area of the elevator car.
